(19) United States
(12) Patent Application Publication
(10) Pub. No.: US 2011/0300376 A1
(43) Pub. Date: Dec. 8, 2011

(54) REINFORCEMENT OF PAPER PULP-BASED MATERIALS USING A REACTIVE ALKYD OLIGOMER CAPABLE OF FORMING A REPROCESSABLE REINFORCEMENT RESIN IN SITU

(76) Inventors: Isao Noda, Fairfield, OH (US); Shrish Yashwant Rane, Madeira, OH (US); William Maxwell Allen, Liberty, OH (US)

(21) Appl. No.: 13/152,845

(22) Filed: Jun. 3, 2011

Related U.S. Application Data
(60) Provisional application No. 61/351,136, filed on Jun. 3, 2010.

(51) Int. Cl. B32B 27/10; B05D 7/00; B05D 3/00; D21B 1/32

(52) U.S. Cl. 428/342; 162/4; 427/391

(57) ABSTRACT

Disclosed herein are paper pulp-based materials that are reinforced with reprocessable alkyd resins, which are formed in situ with the materials. Also disclosed herein are methods for coating paper pulp-based materials with alkyd resins, and methods of recycling alkyd resin coated paper pulp-based materials.

### CROSS REFERENCE TO RELATED APPLICATION

This application claims the benefit of U.S. Provisional Application No. 61351136 filed Jun. 3. 2010.

### FIELD OF THE INVENTION

This disclosure relates to the reinforcement of paper pulp-based materials using a reprocessable alkyd resin coating that is formed in situ with the materials, methods of coating paper pulp-based materials with an alkyd resin, and uses thereof.

### BACKGROUND OF THE INVENTION

Paper pulp-based materials, such as paper, cover stock, and paperboard (e.g., containerboard, linerboard, corrugated fiberboard) can be coated with a reinforcement resin to increase their mechanical properties such as strength and water resistance. One type of coating traditionally used to reinforce paper pulp-based materials is made from high molecular weight, viscous polymers. This polymeric film-based coating is applied to a paper pulp-based material after it has been manufactured, via a co-extrusion process, at high temperatures. Although polymeric film-based coatings provide moisture resistance, low vapor permeability, aesthetic benefits, and do not require a curing step, they have minimal ability to penetrate into or react with the cellulosic structure of the paper pulp-based material. This lack of penetration into the paper pulp-based material limits the potential reinforcement ability of polymeric film-based coatings. Further, polymer film-based coatings are not easily recyclable. To recycle a paper pulp-based material with a polymeric film-based coating, the coating must first be separated from the paper pulp-based material using expensive, off-line, solvent-based processes.

Wax coatings are also commonly used to reinforce paper pulp-based materials because they result in a uniform application and do not require a curing step. However, these coatings must be applied to a paper pulp-based material in a separate, off-line step at high cost. Further, the high viscosity of wax coatings prevents them from easily penetrating into or reacting with the cellulosic structure of the paper pulp-based material, which limits the potential reinforcement ability of the wax coating. Further still, wax coatings cannot be recycled.

Polyvinyl alcohol (PVOH) and soy-based polymeric coatings have been used as alternatives to polymeric film-based coatings and wax coatings. PVOH and soy-based coatings are mixed into a slurry and sprayed or kiss-rolled onto a wet paper pulp-based sheet during the paper making process, right before the sheet enters a series of dryers. PVOH and soy-based coatings can be applied to the paper pulp-based material with starch and/or other additives, and can be recycled to some extent by diluting them with water. However, PVOH and soy-based coatings are expensive relative to polymeric film-based coatings and wax coatings, they must be mixed with starch and other additives as a slurry prior to application, and require comparatively high application temperatures (e.g. 60° C. to 70° C.).

### SUMMARY OF THE INVENTION

Disclosed herein are products that include a paper pulp-based article and a reprocessable alkyd resin. The alkyd resin is formed in situ with the article and coats the article in an amount, on a dry weight basis, of about 1 gram per square meter of the article (g/m²) to about 20 g/m². The product has a burst strength determined by TAPPI T810 that is at least about 5% greater than that of the article, and a ring crush determined by TAPPI T822 that is at least about 5% greater than that of the article. The product can include an additive such as, for example, plasticizers, tackifiers, fillers, nanoparticles, pigments, reaction accelerants, talc, and mixtures thereof.

Another aspect of the invention is a method for producing a reinforced paper pulp-based material. The method includes coating a paper pulp-based article with a prepolymer liquid in an amount of about 1 gram of the prepolymer liquid per square meter of the article (g/m²) to about 30 g/m². The prepolymer liquid is then cured. The prepolymer is composed of alkyd oligomers, polyols, excipients, and mixtures thereof, and has a viscosity of about 0.001 kg·m⁻¹·s⁻¹ to about 1 kg·m⁻¹·s⁻¹ at an application temperature of about 20° C. to about 50° C. In some embodiments of this aspect of the invention, the prepolymer liquid contains about 45 wt. % to about 99 wt. % water, based on the total weight of the prepolymer liquid, and is substantially free of nonaqueous solvents. In alterative embodiments of this aspect of the invention, the prepolymer liquid is neat (i.e., is substantially free of water and nonaqueous solvents). The prepolymer liquid can further include a catalyst capable of accelerating ester condensation.

Yet another aspect of the invention includes a method for manufacturing pulp from a product that is composed of a paper pulp-based article that is coated with a reprocessable alkyd resin. The alkyd resin coating can be formed in situ with the article and coats the article in an amount, on a dry weight basis, of about 1 gram per square meter of the article (g/m²) to about 20 g/m². In this method, water and acid or base, in the absence of non-aqueous solvents, are added to the product to form a mixture, and the mixture is heated to a temperature of about 50°C to about 120° C. for a period of at least about 5 minutes.

Additional features of the invention may become apparent to those skilled in the art from a review of the following detailed description, taken in conjunction with the examples and the appended claims.

### DETAILED DESCRIPTION OF THE INVENTION

It has now been found that alkyd resin coatings formed in situ can reinforce paper pulp-based materials. Alkyd resins are formed by the condensation of polyols with polyfunctional acids, anhydrides, or a mixture of polyfunctional acids and anhydrides to result in ester moieties. As used herein, “condensation” is the reaction of an alcohol with a carboxylic acid or carboxylic acid derivative to form an ester with the liberation of a water by-product. Because the individual polyol, acid, and anhydride monomers have multiple functional groups, generally at least three, alkyd resins form a cross-linked molecular network upon curing, which is characteristic of classical thermoset resins. These cross-linked molecular networks impart mechanical reinforcement to the paper pulp-based material (e.g., an increase in mechanical strength of up to about 50% and an increase in ring crush of up to about 120%) and have superior dimensional stability.

Coating paper pulp-based materials with alkyd resins that are formed in situ with the materials results in significant cost savings and economic advantages. A paper pulp-based material at a particular basis weight (e.g., 99 g/m²) coated with an alkyd resin that is formed in situ with the paper pulp-based material has a mechanical strength that is the same as or greater than an uncoated paper pulp-based material at a greater basis weight (e.g., 117 g/m²). By coating a paper pulp-based material with an alkyd resin that is formed in situ with the material, the thickness of the paper pulp-based material can be down-gauged, resulting in a lighter material without a compromise in mechanical strength. Thus, cost savings are achieved because less pulp is required during the manufacturing process and because the lighter materials are less expensive to transport and store. Further, the alkyd resin starting materials are themselves inexpensive, especially when compared to the materials used for PVOH coatings (e.g., $1.00 per pound versus $1.50 per pound). Paper pulp-based materials coated with alkyd resins that are formed in situ are also advantageous because they have increased water resistance when compared to uncoated materials, can easily be commercially employed through the addition of a slot coating stage on the line, and can have varied compositions, depending on the choice of alkyd starting materials.

The process of forming an alkyd resin coating in situ with a paper pulp-based material is also advantageous. The alkyd resin coating is applied to the paper pulp-based material as a low viscosity, prepolymer liquid containing low molecular weight alkyd oligomers. This prepolymer liquid can be applied neat, as a dispersion, or as a solution in water. The low molecular weight alkyd oligomers of the prepolymer liquid react with themselves as the prepolymer liquid dries on the paper pulp-based material to result in an alkyd resin coating that has been cured in situ. Actively promoting water evaporation can accelerate this curing process. Surprisingly and unexpectedly, heating the prepolymer liquid to a temperature that promotes curing (e.g., 108° C.) does not cause the paper pulp-based material to burn. Because the prepolymer liquid has a low viscosity, it is easy to handle and can be applied to the paper pulp-based material at low temperatures. Further, the low viscosity of the prepolymer liquid allows it to diffuse into the upper layers of the paper pulp-based material before cross-linking, which increases the reinforcement potential of the cured alkyd resin. Further still, and without intending to be bound by any particular theory, the reactive alkyd oligomers of the prepolymer liquid are able to react with the cellulosic structure of the paper pulp-based material, still further increasing the reinforcement potential of the alkyd resin coating. In contrast, polymeric film-based coatings and wax coatings are applied to paper pulp-based materials as viscous, high molecular weight polymers. The high viscosity of the polymeric film-based coating requires high application temperatures, and prevents these coatings from diffusing into the upper layers of paper pulp-based materials for an enhancement of reinforcement.

Alkyd resin reinforcement coatings are further advantageous because they are easily recyclable and reprocessable, unlike other types of coatings commonly used in the art. The recycling of an alkyd resin coated paper pulp-based material is possible because of the chemical structure of alkyd resins, which are cross-linked with relatively labile ester bonds. When these ester bonds are exposed to heat and water, the alkyd resin coating is hydrolyzed into alkyd monomers and oligomers. Thus, alkyd resin coated paper pulp-based materials can be repulped simply and inexpensively by exposure to heat and water, and do not require the separate, expensive, solvent-based processes typically necessary to first separate the coating from the paper pulp-based material. Further, the ability of the alkyd resin coating to be degraded into monomers and oligomers avoids the formation of “stickies.” During the recycling of conventionally coated paper pulp-based materials, polymers from the coatings tend to agglomerate together with fibers and other substances to form stickies, which reduce the quality of the product and cause the sticking of paper-machine parts during reprocessing. Eliminating the problem of stickies during the reprocessing of coated paper pulp-based materials has been a long felt need in the art.

In one aspect, the invention relates to a paper pulp-based article that is coated with a reprocessable alkyd resin. The alkyd resin coats the article in an amount of about 1 gram per square meter (g/m²)to about 20 g/m², preferably in an amount of about 5 g/m² to about 15 g/m², more preferably in an amount of about 8 g/m² to about 10 g/m², on a dry weight basis. The alkyd resin coated article has a burst strength determined by TAPPI T810 that is at least 5% greater, preferably at least about 10% greater, and a ring crush determined by TAPPI T822 that is at least 10% greater, preferably at least 20% than that of a corresponding uncoated article. The alkyd reinforcement resin is formed in situ with the article by coating the article with a prepolymer liquid and subsequently curing the prepolymer liquid to form the reprocessable alkyd reinforcement resin.

The paper pulp-based article refers to any paper-based material. Nonlimiting examples of paper pulp-based articles include paper, cover stock, card stock, paperboard, containerboard, linerboard, and corrugated fiberboard. As used herein, the term “paper” refers to a paper pulp based-article that is less than about 0.20 mm thick (e.g., about 0.07 mm to about 0.20 mm thick) and has a basis weight of less than about 120 g/m² (e.g., from about 60 g/m² to about 120 g/m²). As used herein, the terms “cover stock” and “card stock” are interchangeable and refer to a paper pulp-based article that is about 0.20 mm to about 0.25 mm thick and has a basis weight of about 120 g/m² to about 220 g/m². As used herein, the term “paperboard” m refers to a paper pulp-based article that is at least 0.25 mm thick and has a basis weight greater than about 75 g/m² (e.g., about 100 g/m² to about 450 g/m²). As used herein, the term “containerboard” refers to a type of paperboard that is used for the production of corrugated fiberboard. As used herein, the term “linerboard” refers to a type of paperboard that is used for the flat facings of corrugated fiberboard. As used herein, the term “corrugated fiberboard” refers to a type of containerboard consisting of a fluted corrugated sheet and one or two flat linerboards. In some preferred embodiments, the paper pulp-based article is linerboard or corrugated fiberboard.

The reprocessable alkyd resin is cross-linked with ester bonds formed by the condensation of polyols with an excipient selected from the group consisting of polyfunctional acids, anhydrides, and a mixture of polyfunctional acids and anhydrides. Preferably, the reprocessable alkyd resin does not contain a substantial amount of functional groups that can cause cross-linking by free radical addition chemistry (i.e. no more than 10 wt. % of carbon-carbon bonds are alkenes and/or alkynes). When the excipient is a polyfunctional acid, the molar ratio of total acid moieties on the polyfunctional acid to alcohol moieties on the polyol is about 10:1 to about 1:10, more preferably about 3:1 to about 1:3, and even more preferably about 1:1. When the excipient is an anhydride, the molar ratio of total anhydride moieties on the anhydride to total alcohol moieties on the polyol is about 5:1 to about 1:5, preferably about 1.5:1 to about 1:1.5 even more preferably about 0.5:1.

The polyol preferably is a molecule that includes at least two alcohol moieties, preferably at least three alcohol moieties. Preferably, the alcohol moieties are primary hydroxyl groups. Nonlimiting examples of polyols include glycerol, 1,3-propanediol, pentaerythritol, dipentaerythritol, trimethylolpropane, trimethylolethane, ethylene glycol, diethylene glycol, polyglycerol. diglycerol, triglycerol, 1,2-propanediol, 1,4-butanediol, neopentylglycol, hexanediol, hexanetriol, erythritol, xylitol, malitol, mannitol, polyvinyl alcohol, and mixtures thereof. In some specific embodiments, the polyol is selected from the group consisting of glycerol, pentaerythritol, trimethylolpropane, trimethylolethane, and mixtures thereof. In some preferred embodiments, the polyol is glycerol.

The excipient is selected from the group consisting of a polyfunctional acid. an anhydride, and mixtures thereof. The polyfunctional acid preferably is a molecule that includes at least two carboxylic acid moieties, more preferably at least three carboxylic acid moieties. The anhydride preferably is a molecule that includes at least one anhydride moiety. Nonlimiting examples of the excipient include adipic acid, maleic acid, succinic acid, sebacic acid, suberic acid, fumaric acid, glutaric acid, phthalic acid, malonic acid, isophthalic acid, terephthalic acid, azelaic acid, dimer acid, dimethylolpropionic acid, maleic anhydride, succinic anhydride, phthalic anhydride, trimellitic anhydride, polyacrylic acid, polymethacrylic acid, and mixtures thereof. In some specific embodiments, the excipient is an anhydride selected from the group consisting of maleic anhydride, succinic anhydride, phthalic anhydride, and mixtures thereof. In some preferred embodiments, the excipient is selected from the group consisting of maleic anhydride, citric acid, and mixtures thereof.

The burst strength of the alkyd resin coated paper pulp-based article can be at least 5% greater, preferably at least 10% greater, and up to about 50% greater than the burst strength of a corresponding uncoated article. In some embodiments of this aspect of the invention, the burst strength of the alkyd resin coated paper pulp-based article can be up to about 25% greater than the burst strength of a corresponding uncoated article (determined by TAPPI T810). For example, the burst strength of the coated article can be about 5% to about 30% greater than the burst strength of a corresponding uncoated article.

The ring crush of the alkyd resin coated paper pulp-based article can be at least 10% greater, preferably at least 20% greater, than the ring crush of a corresponding uncoated article. In some embodiments of this aspect of the invention, the ring crush of the alkyd resin coated paper pulp-based article can, unexpectedly, be up to about 120% greater than the ring crush of a corresponding uncoated article (determined by TAPPI T822). For example, the ring crush of the coated article can be about 20% to about 60% greater than the ring crush of a corresponding uncoated article.

In some embodiments of this aspect of the invention, the alkyd resin coated paper pulp-based article is reinforced compared to a corresponding uncoated article of the same basis weight. As used herein, the term “reinforced” refers to an alkyd resin coated paper pulp-based article that has the same or greater mechanical strength than an uncoated article with a greater basis weight. For example, an alkyd resin coated paper pulp-based article with a basis weight of 99 g/m² is reinforced when it has the same or greater mechanical strength than an uncoated article with a basis weight of 117 g/m².

The reprocessable alkyd resin can further include additives. Nonlimiting examples of additives include plasticizers, tackifiers, fillers, nanoparticles, pigments, reaction accelerants, talc, or mixtures thereof. In some embodiments, the filler is selected from the group consisting of unmodified clays, mica, titanium dioxide, and mixtures thereof.

In another aspect, the invention relates to a method for coating a paper pulp-based article with a reprocessable alkyd resin. In this method, a paper pulp-based article is coated with a prepolymer liquid in an amount of about 1 gram of the prepolymer liquid per square meter of the article (g/m²)to about 30 g/m², preferably about 6 g/m² to about 25 g/m², more preferably about 10 g/m² to about 18 g/m². The prepolymer liquid is then cured. The prepolymer is composed of alkyd oligomers, polyols, excipients, and mixtures thereof, and has a viscosity of about 0.001 kg·m⁻¹·s⁻¹ to about 1 kg·m⁻¹·s⁻¹, preferably about 0.01 kg·m⁻¹·s⁻¹ to about 0.1 kg·m⁻¹·s⁻¹, at the temperature at which the prepolymer will be applied an application temperature). The application temperature generally will be about 0° C. to about 50° C. For example, in a cold-weather environment that experiences a temperature of about 0° C. to about 10° C., the viscosity of the prepolymer during application to the paper pulp-based article is about 0.001 kg·m⁻¹·s⁻¹ to about 1 kg·m⁻¹·s⁻¹, preferably about 0.01 kg·m⁻¹·s⁻¹ to about 0.1 kg·m⁻¹·s⁻¹. In a warmer-temperature environment that experiences a temperature of about 10° C. to about 30° C., the viscosity of the prepolymer during application to the paper pulp-based article is about 0.001 kg·m⁻¹·s⁻¹ to about 1 kg·m⁻¹·s⁻¹, preferably about 0.01 kg·m⁻¹·s⁻¹ to about 0.1 kg·m⁻¹·s⁻¹. Similarly, in a hot environment that may experience a temperature of about 30° C. to about 50° C., the viscosity of the prepolymer during application to the paper pulp-based article is about 0.001 kg·m⁻¹·s⁻¹ to about 1 kg·m⁻¹·s⁻¹, preferably about 0.01 kg·m⁻¹·s⁻¹ to about 0.1 kg·m⁻¹·s⁻¹. The viscosity of the prepolymer liquid can be determined, for example, using a Brookfield (HBTD) viscometer.

Curing the prepolymer liquid can occur by any method commonly used in the art such as, for example, by heating or by air drying at ambient temperature. In some embodiments, curing the prepolymer liquid includes heating it at a temperature of about 100° C. to about 120° C., preferably about 105° C. to about 115° C., for about 1 minute to about 30 minutes, preferably for about 3 minutes to about 10 minutes.

In some embodiments, the prepolymer liquid includes about 45 wt. % to about 99 wt. % water, preferably about 75 wt. % to about 90 wt. % water, based on the total weight of the prepolymer liquid, and is substantially free of a nonaqueous solvent (i.e., less than 5 wt. % nonaqueous solvent, based on the total weight of the prepolymer liquid. In optional embodiments, the prepolymer liquid is substantially free of both water and solvent (i.e., less than 5 wt. % water and less than 5 wt. % solvent, based on the total weight of the prepolymer liquid), In these embodiments, the prepolymer liquid is neat.

The alkyd oligomer in this aspect of the invention preferably is a compound that results from the condensation of a polyol with polyfunctional acids, anhydrides, or a mixture of polyfunctional acids and anhydrides to form a product with up to about 10, preferably up to about 7, more preferably up to about 5 (e.g., about 4) monomer units and/or a molecular weight of about 200 g/mol to about 3000 g/mol, preferably about 300 g/mol to about 2000 g/mol.

The polyol in this aspect of the invention preferably is a molecule that includes at least two alcohol moieties, more preferably at least three alcohol moieties, as previously described herein. Preferably, the alcohol moieties are primary hydroxyl groups. The excipient in this aspect of the invention is selected from the group consisting of a polyfunctional acid, an anhydride, and mixtures thereof. The polyfunctional acid preferably is a molecule that includes at least two carboxylic acid moieties, more preferably at least three carboxylic acid moieties, as previously described herein. The anhydride preferably is a molecule that includes at least one anhydride moiety, as previously described herein. When the excipient is a polyfunctional acid, the molar ratio of total acid moieties on the polyfunctional acid to alcohol moieties on the polyol is about 10:1 to about 1:10, more preferably about 3:1 to about 1:3, and even more preferably about 1:1. When the excipient is an anhydride, the molar ratio of total anhydride moieties on the anhydride to total alcohol moieties on the polyol is about 5:1 to about 1:5, preferably about 1.5:1 to about 1:1.5 even more preferably about 0.5:1.

In some embodiments of this aspect of the invention, a catalyst can be added to the prepolymer liquid. The catalyst aids in accelerating ester condensation (e.g., increases the rate of ester condensation from about two times faster to about ten times faster than ester condensation with the same conditions but without a catalyst). The catalyst can be a Lewis acid, such as stannous octoate and aluminum chloride, or an inorganic acid, such as a sulfonic acid. Nonlimiting examples of sulfonic acids that can be used as catalysts for the reprocessing of alkyd resins include methanesulfonic acid, p-toluenesulfonic acid, benzenesulfonic acid, chlorosulfonic acid, ethanesulfonic acid, aniline-2-sulfonic acid, dodecylbenzenesulfonic acid, poly(4-styrenesulfonic acid), and mixtures thereof. The catalyst is present (if at all) in an amount that is about 0.05 wt. % to about 2 wt. %, based on the total weight of the prepolymer liquid.

In optional embodiments, the prepolymer liquid can include an additive, such as, for example, plasticizers, tackifiers, fillers, nanoparticles, pigments, reaction accelerants, talc, or mixtures thereof, as previously described herein.

The paper pulp-based article in this aspect of the invention can refer to any paper-based material. Nonlimiting examples of paper pulp-based articles include paper, cover stock, card stock, paperboard, containerboard, linerboard, and corrugated fiberboard, as previously described herein. In some preferred embodiments, the paper pulp-based article is linerboard or corrugated fiberboard.

In another aspect, the invention relates to a paper pulp-based article coated with a reprocessable alkyd resin that is formed by the method previously described herein. In this method, a paper pulp-based article is coated with a prepolymer liquid in an amount of about 1 gram of the prepolymer liquid per square meter of the article (g/m²)to about 30 g/m², preferably about 6 g/m² to about 25 g/m², more preferably about 10 g/m² to about 18 g/m². The prepolymer liquid is then cured. The prepolymer is composed of alkyd oligomers, polyols, excipients, and mixtures thereof, and has a viscosity of about 0.001 kg·m⁻¹·s⁻¹ to about 1 kg·m⁻¹·s⁻¹, preferably about at about 0.01 kg·m⁻¹·s⁻¹ to about 0.1 kg·m⁻¹·s⁻¹, at an application temperature of about 20° C. to about 50° C.

Curing the prepolymer liquid can occur by any method commonly used in the art, as previously described herein. In some embodiments, curing the prepolymer liquid includes heating it at a temperature of about 100° C. to about 120° C., preferably about 105° C. to about 110° C., for about 1 minute to about 30 minutes, preferably for about 3 minutes to about 10 minutes.

In some embodiments, the prepolymer liquid includes about 45 wt. % to about 99 wt. % water, preferably about 75 wt. % to about 90 wt. % water, based on the total weight of the prepolymer liquid, and is substantially free of nonaqueous solvent, as previously described herein. In optional embodiments, the prepolymer liquid is substantially free of water and solvent (i.e., less than 5 wt. % water and less than 5 wt. % solvent, based on the total weight of the prepolymer liquid). In these embodiments, the prepolymer liquid is neat.

The composition and ratios of alkyd oligomer, polyol, and excipients in this aspect of the invention are as previously described herein. In some embodiments of this aspect of the invention, a catalyst can be added to the prepolymer liquid, as previously described herein. In optional embodiments, the prepolymer liquid can include an additive, as previously described herein. The paper pulp-based article in this aspect of the invention can refer to any paper-based material, as previously described herein.

As previously described herein, alkyd resin reinforcement coatings have the advantage of being easily recyclable and reprocessable, unlike other types of coatings commonly used in the art. Thus, in another aspect, the invention relates to a method for reprocessing a paper pulp-based article coated with an alkyd resin. The alkyd resin coating of the invention can be formed in situ with the article and coats the article in an amount, on a dry weight basis, of about 1 gram per square meter of the article (g/m²)to about 20 g/m². The alkyd resin coated paper pulp-based article has a burst strength determined by TAPPI T810 that is at least 5%, preferably at least about 10% greater than that of the article, and a ring crush that is at least about 10% greater, preferably at least about 20% greater than that of the article.

Methods for reprocessing an alkyd resin coated paper pulp-based article include any repulping or deinking process typically used in the art of paper making. When a deinking process is used, pH adjusters such as sodium silicate and sodium hydroxide, and a bleaching agent, such as hydrogen peroxide, are typically added to the coated paper pulp-based article during reprocessing.

In a preferred embodiment of this aspect of the invention, water and an acid or a base are added to a paper pulp-based article coated with an alkyd resin, in the absence of non-aqueous solvent, to form a mixture. The mixture is heated to a temperature of about 50° C. to about 120° C. for a period of at least about 3 minutes, preferably about 5 minutes to about 30 minutes, to result in a pulp. Although the relationship between the temperature and time used for reprocessing an alkyd resin coated paper pulp-based material depends on the composition of the specific alkyd resin coating, in general, longer reaction times will be needed at a lower processing temperatures. The acid or base can promote alkyd resin degradation by accelerating hydrolysis of the ester crosslinks of the alkyd resin. Nonlimiting examples of the acid include methanesulfonic acid, p-toluenesulfonic acid, benzenesulfonic acid, chlorosulfonic acid, ethanesulfonic acid, aniline-2-sulfonic acid. dodecylbenzenesulfonic acid, poly(4-styrenesulfonic acid), and mixtures thereof. Nonlimiting examples of the base include sodium hydroxide, potassium hydroxide, and mixtures thereof.

### EXAMPLES

The following examples are provided to illustrate the invention, but are not intended to limit the scope thereof. Example 1 describes the preparation of a reprocessable alkyd resin coated linerboard. Example 2 describes the mechanical properties of a 99 g/m² linerboard coated with a reprocessable alkyd resin. Example 3 describes the effect of the amount of alkyd resin coating on the burst strength and ring crush of 99 g/m² linerboards. Example 4 describes the reprocessability of alkyd resin coated paper.

### Example 1

In this example, a reprocessable alkyd resin coated linerboard was prepared. Glycerol (1 molar equivalent) and citric acid (1 molar equivalent) were heated at 100° C. in a hot air drying oven for 60 minutes to form a mixture containing glycerol citrate alkyd oligomers, glycerol, and citric acid. This mixture was added to different amounts of hot water to form prepolymer liquids with the following concentrations: 50 wt. %, 60 wt. %, 70wt. %, 80 wt. %, and 90 wt. % water, based on the total weight of the prepolymer liquid. Each prepolymer liquid was applied to a linerboard (basis weight of 99 g/m²) at 20.5° C., and in a coat weight of 12 g/m², 14 g/m², and 16 g/m², using a sheet-fed flooded nip size press. The weight of the coating applied was altered by adjusting the pressure and speed of the size press. The prepolymer liquid was then dried at 108° C. for about 3 minutes or for about 10 minutes.

### Example 2

The mechanical properties of the coated linerboards from Example 1 were determined. Specifically, the burst strength (TAPPI T810), caliper (TAPPI T411), water resistance (30 minute Cobb test, TAPPI T441), porosity (TAPPI T460), and ring crush (TAPP) T822) were determined for each alkyd resin coated linerboard. The results were compared to an uncoated linerboard with a basis weight of 117 g/m². Table 1 shows the mechanical properties of uncoated linerboards with basis weights of 99 g/m² and 117 g/m².

TABLE 1

| | 99 g/m² Linerboard | 117 g/m² Linerboard |
|---|---|---|
| Basis Weight | 99 ± 1.5 g/m² | 117 ± 1.7 g/m² |
| Caliper | 191 ± 2 μm | 207 ± 2.7 μm |
| Burst Strength | 273 ± 9.45 kPa | 282 ± 10.7 kPa |
| Ring Crush | 0.7 ± 0.05 kN/m | 0.7 ± 0.06 kN/m |
| Porosity | 6.5 ± 0.4 sec/100 mL | 6.8 ± 1 sec/100 mL |
| Cobb Test | 185 ± 3 g/m² | 217 ± 2 g/m² |
| (Water Resistance) | water absorption | water absorption |

Burst Strength

The burst strength of an alkyd resin coated 99 g/m² linerboard increased with coat weight and the amount of alkyd oligomers and monomers in the prepolymer liquid. The burst strength of 99 g/m² linerboards that were coated with a prepolymer liquid having about 50 wt. % to about 70 wt. % water, based on the total weight of the prepolymer liquid, surpassed the burst strength of an uncoated 117 g/m² linerboard, as shown in Table 2.

TABLE 2

| Amount of Water | Coat weight | 3 Minute Drying | 10 Minute Drying |
|---|---|---|---|
| (wt. %) | (g/m²) | Time | Time |
| 90% | 12 | 277 ± 7.1 kPa | 278 ± 9.4 kPa |
| | 14 | 284 ± 2.4 kPa | 283 ± 6.6 kPa |
| | 16 | 289 ± 7.2 kPa | 288 ± 5.3 kPa |
| 80% | 12 | 283 ± 5.1 kPa | 284 ± 6.5 kPa |
| | 14 | 286 ± 9.1 kPa | 288 ± 5.9 kPa |
| | 16 | 289 ± 9.4 kPa | 291 ± 7.8 kPa |
| 70% | 12 | 299 ± 8.1 kPa | 308 ± 7.7 kPa |
| | 14 | 308 ± 6.5 kPa | 314 ± 6.7 kPa |
| | 16 | 311 ± 6.0 kPa | 322 ± 9.8 kPa |
| 60% | 12 | 309 ± 9.0 kPa | 318 ± 9.1 kPa |
| | 14 | 311 ± 7.6 kPa | 323 ± 8.0 kPa |
| | 16 | 322 ± 6.3 kPa | 327 ± 8.7 kPa |
| 50% | 12 | 323 ± 7.3 kPa | 337 ± 4.6 kPa |
| | 14 | 326 ± 7.3 kPa | 345 ± 8.9 kPa |
| | 16 | 333 ± 6.1 kPa | 348 ± 5.8 kPa |

Caliper

The caliper of an alkyd resin coated 99 g/m² linerboard increased with the amount of water in the prepolymer liquid. This increase in caliper with the amount of water may be due to fiber swelling. The caliper of the linerboard that was coated with a prepolymer liquid having about 50 wt. % water, based on the total weight of the prepolymer liquid, was similar to the caliper of the uncoated 117 g/m² linerboard, as shown in Table 3. The increase in caliper due to the alkyd resin coating was also found to increase ring crush properties of the linerboards because of an increase in flexural stiffness with caliper.

TABLE 3

| Amount of Water | Coat weight | 3 Minute Drying | 10 Minute Drying |
|---|---|---|---|
| (wt. %) | (g/m²) | Time | Time |
| 90% | 12 | 203 ± 2.5 μm | 204 ± 3.6 μm |
| | 14 | 204 ± 3.2 μm | 204 ± 2.1 μm |
| | 16 | 207 ± 2.5 μm | 207 ± 2.1 μm |
| 80% | 12 | 199 ± 2.7 μm | 199 ± 2.1 μm |
| | 14 | 201 ± 3.8 μm | 202 ± 2.0 μm |
| | 16 | 204 ± 3.8 μm | 206 ± 2.5 μm |
| 70% | 12 | 194 ± 3.8 μm | 195 ± 3.8 μm |
| | 14 | 200 ± 3.1 μm | 201 ± 3.1 μm |
| | 16 | 202 ± 3.8 μm | 203 ± 3.8 μm |
| 60% | 12 | 196 ± 3.3 μm | 194 ± 3.8 μm |
| | 14 | 195 ± 4.1 μm | 196 ± 2.5 μm |
| | 16 | 198 ± 3.8 μm | 199 ± 3.8 μm |
| 50% | 12 | 192 ± 2.9 μm | 194 ± 2.5 μm |
| | 14 | 194 ± 3.8 μm | 195 ± 3.0 μm |
| | 16 | 197 ± 2.5 μm | 199 ± 2.7 μm |

Ring Crush

The ring crush of an alkyd resin coated 99 g/m² linerboard increased with coat weight, as shown in Table 4.

TABLE 4

| Amount of Water | Coat weight | 3 Minute Drying | 10 Minute Drying |
|---|---|---|---|
| (wt. %) | (g/m²) | Time | Time |
| 90% | 12 | 1.02 ± 0.02 kN/m | 1.02 ± 0.06 kN/m |
| | 14 | 1.09 ± 0.04 kN/m | 1.10 ± 0.05 kN/m |
| | 16 | 1.11 ± 0.04 kN/m | 1.12 ± 0.02 kN/m |
| 80% | 12 | 0.95 ± 0.03 kN/m | 0.91 ± 0.05 kN/m |
| | 14 | 0.96 ± 0.04 kN/m | 0.93 ± 0.06 kN/m |
| | 16 | 0.99 ± 0.05 kN/m | 1.00 ± 0.06 kN/m |
| 70% | 12 | 0.90 ± 0.03 kN/m | 0.93 ± 0.03 kN/m |
| | 14 | 0.92 ± 0.03 kN/m | 0.97 ± 0.05 kN/m |
| | 16 | 0.98 ± 0.04 kN/m | 1.04 ± 0.04 kN/m |
| 60% | 12 | 0.88 ± 0.03 kN/m | 0.88 ± 0.03 kN/m |
| | 14 | 0.90 ± 0.04 kN/m | 0.90 ± 0.04 kN/m |
| | 16 | 0.91 ± 0.06 kN/m | 0.91 ± 0.06 kN/m |
| 50% | 12 | 0.82 ± 0.05 kN/m | 0.87 ± 0.03 kN/m |
| | 14 | 0.89 ± 0.05 kN/m | 0.91 ± 0.08 kN/m |
| | 16 | 0.92 ± 0.05 kN/m | 0.95 ± 0.05 kN/m |

Porosity

The porosity of an alkyd resin coated 99 g/m² linerboard decreased with coat weight and increased with amount of water present in the prepolymer liquid, as shown in Table 5.

TABLE 5

| Amount | | | |
|---|---|---|---|
| of Water | Coat weight | 3 Minute Drying | 10 Minute Drying |
| (wt. %) | (g/m²) | Time | Time |
| 90% | 12 | 7.1 ± 0.5 sec/100 mL | 7.1 ± 0.2 sec/100 mL |
| | 14 | 9.2 ± 0.5 sec/100 mL | 9.2 ± 0.2 sec/100 mL |
| | 16 | 12.1 ± 0.6 sec/100 mL | 12.2 ± 0.6 sec/100 mL |
| 80% | 12 | 8.6 ± 0.2 sec/100 mL | 8.6 ± 0.1 sec/100 mL |
| | 14 | 10.1 ± 0.2 sec/100 mL | 10.2 ± 0.5 sec/100 mL |
| | 16 | 13.3 ± 0.7 sec/100 mL | 13.5 ± 0.5 sec/100 mL |
| 70% | 12 | 12.9 ± 0.8 sec/100 mL | 11.9 ± 0.3 sec/100 mL |
| | 14 | 14.9 ± 0.7 sec/100 mL | 14.4 ± 1.2 sec/100 mL |
| | 16 | 17.2 ± 0.8 sec/100 mL | 16.7 ± 1.0 sec/100 mL |
| 60% | 12 | 17.1 ± 1.0 sec/100 mL | 15.1 ± 0.2 sec/100 mL |
| | 14 | 17.9 ± 0.8 sec/100 mL | 15.2 ± 1.3 sec/100 mL |
| | 16 | 19.0 ± 2.1 sec/100 mL | 16.0 ± 1.0 sec/100 mL |
| 50% | 12 | 18.5 ± 1.2 sec/100 mL | 17.9 ± 0.7 sec/100 mL |
| | 14 | 20.1 ± 1.4 sec/100 mL | 19.5 ± 1.2 sec/100 mL |
| | 16 | 22.7 ± 1.8 sec/100 mL | 21.0 ± 1.5 sec/100 mL |

Cobb Test for Water Resistance (30 minutes)

The water resistance of an alkyd resin coated 99 g/m² linerboard increased with coat weight and with the amount of alkyd oligomers and monomers present in the prepolymer liquid, as shown in Table 6.

TABLE 6

| Amount of Water | Coat weight | 3 Minute Drying | 10 Minute Drying |
|---|---|---|---|
| (wt. %) | (g/m²) | Time | Time |
| 90% | 12 | 182 ± 3 g/m² | 181 ± 2 g/m² |
| | 14 | 179 ± 3 g/m² | 178 ± 3 g/m² |
| | 16 | 171 ± 2 g/m² | 170 ± 2 g/m² |
| 80% | 12 | 180 ± 3 g/m² | 179 ± 3 g/m² |
| | 14 | 174 ± 3 g/m² | 171 ± 1 g/m² |
| | 16 | 172 ± 2 g/m² | 172 ± 3 g/m² |
| 70% | 12 | 169 ± 1 g/m² | 161 ± 3 g/m² |
| | 14 | 161 ± 2 g/m² | 159 ± 1 g/m² |
| | 16 | 163 ± 1 g/m² | 157 ± 2 g/m² |
| 60% | 12 | 154 ± 2 g/m² | 150 ± 3 g/m² |
| | 14 | 147 ± 1 g/m² | 140 ± 1 g/m² |
| | 16 | 151 ± 2 g/m² | 144 ± 2 g/m² |
| 50% | 12 | 152 ± 2 g/m² | 148 ± 2 g/m² |
| | 14 | 146 ± 2 g/m² | 141 ± 2 g/m² |
| | 16 | 143 ± 1 g/m² | 140 ± 2 g/m² |

### Example 3

The effect of the amount of alkyd resin coating, on a dry weight basis, on the burst strength and ring crush of 99 g/m² linerboards was determined. The alkyd resin coated linerboards were prepared as described in Example 1. The burst strength and ring crush were tested as described in Example 2. The results were compared to uncoated linerboards with basis weights of 99 g/m² and 117 g/m² (Table 7).

TABLE 7

| | Final | Burst Strength | | Ring Crush | |
|---|---|---|---|---|---|
| | Coating | (kPa) | | (kN/m) | |
| | (solids) | 3 | 10 | 3 | |
| | Basis | minutes | minutes | minutes | 10 minutes |
| Linerboard | weight | of drying | of drying | of drying | of drying |
| Basis Weight | g/m² | at 108° C. | at 108° C. | at 108° C. | at 108° C. |
| 99 g/m² | 0 | 273 | 273 | 0.7 | 0.7 |
| 117 g/m² | 0 | 282 | 282 | 0.7 | 0.7 |
| 99 g/m² | 1.2 | 277 | 278 | 1.02 | 1.02 |
| 99 g/m² | 1.4 | 284 | 283 | 1.09 | 1.1 |
| 99 g/m² | 1.6 | 289 | 288 | 1.11 | 1.12 |
| 99 g/m² | 2.2 | 283 | 284 | 0.95 | 0.91 |
| 99 g/m² | 2.8 | 286 | 288 | 0.96 | 0.93 |
| 99 g/m² | 3.2 | 289 | 291 | 0.99 | 1 |
| 99 g/m² | 3.6 | 299 | 308 | 0.9 | 0.93 |
| 99 g/m² | 4.2 | 308 | 314 | 0.92 | 0.97 |
| 99 g/m² | 4.8 | 311 | 322 | 0.98 | 1.04 |
| 99 g/m² | 4.8 | 309 | 318 | 0.88 | 0.88 |
| 99 g/m² | 5.6 | 311 | 323 | 0.9 | 0.9 |
| 99 g/m² | 6.4 | 322 | 327 | 0.91 | 0.91 |
| 99 g/m² | 6 | 323 | 337 | 0.82 | 0.87 |
| 99 g/m² | 7 | 326 | 345 | 0.89 | 0.91 |
| 99 g/m² | 8 | 333 | 348 | 0.92 | 0.95 |

### Example 4

The reprocessability of an alkyd resin coated paper was compared to the reprocessability of a polyvinyl alcohol (PVOH) coated paper. Coated paper samples were prepared by applying to a paper either 13 wt. %, 22 wt. %, or 50 wt. % of PVOH, based on the total weight of a solution of PVOH in water, or 9 wt. %, 17 wt. %, or 25 wt. % of glycerol citrate alkyd oligomers and monomers, based on the total weight of a prepolymer liquid of glycerol citrate alkyd oligomers and monomers in water. The coated paper samples were then cured at about 100° C. for about 10 minutes.

The reprocessability of the coated paper samples was determined by introducing the coated paper samples to water at a temperature of about 60° C. to about 65° C., slowly stirring the resulting mixture for 30 minutes, and then drying the samples. The amount of residual coating remaining on the paper samples was determined.

Under the process conditions, all traces of alkyd resin coating was removed from all three of the paper samples that were initially coated with alkyd resin. In contrast, 0.34%, 4.89%, and 25% of the PVOH coating remained on the 13 wt. %, 22 wt. %, or 50 wt. % PVOH coated paper samples, respectively.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A product comprising a paper pulp-based article and a reprocessable alkyd resin, wherein the alkyd resin is formed in situ with the article and coats the article in an amount, on a dry weight basis, of about 1 gram per square meter of the article (g/m²) to about 20 g/m², and wherein the product has a burst strength determined by TAPPI T810 that is at least 5% greater than that of the article.

2. The product of claim 1, wherein the burst strength is at least 10% greater than that of the article.

3. The product of claim 1, wherein the product has a ring crush determined by TAPPI T822 that is at least 10% greater than that of the article.

4. The product of claim 1, wherein the amount of alkyd resin is about 5 g/m² to about 15 g/m².

5. The product of claim 1, wherein the article is selected from the group consisting of paper, cover stock, and paperboard.

6. The product of claim 1, wherein the alkyd resin is the condensation product of an excipient selected from the group consisting of a polyfunctional acid, an anhydride, and mixtures thereof, and a polyol.

7. The product of claim 6, wherein the polyol is selected from the group consisting of glycerol, 1,3-propanediol, pentaerythritol, dipentaerythritol, trimethylolpropane, trimethylolethane, ethylene glycol, diethylene glycol, polyglycerol, diglycerol, triglycerol, 1,2-propanediol, 1,4-butanediol, neopentylglycol, hexanediol, hexanetriol, erythritol, xylitol, malitol, mannitol, polyvinyl alcohol, and mixtures thereof,

8. The product of claim 6, wherein the excipient is selected from the group consisting of adipic acid, maleic acid, succinic acid, sebacic acid, suberic acid, fumaric acid, glutaric acid, phthalic acid, malonic acid, isophthalic acid, terephthalic acid, azelaic acid, dimer acid, dimethylolpropionic acid, maleic anhydride, succinic anhydride, phthalic anhydride, trimellitic anhydride, polyacrylic acid, polymethacrylic acid, and mixtures thereof.

9. The product of claim 6, wherein the molar ratio of total acid moieties on the polyfunctional acid to total alcohol moieties on the polyol is about 10:1 to about 1:10.

10. The product of claim 9, wherein the molar ratio is about 3:1 to about 1:3.

11. The product of claim 6, wherein the molar ratio of total anhydride moieties on the anhydride compound to total alcohol moieties on the polyol is about 5:1 to about 1:5.

12. The product of claim 1, wherein the alkyd resin further comprises an additive.

13. The product of claim 12, wherein the additive is selected from the group consisting of plasticizers, tackifiers, fillers, nanoparticles, pigments, reaction accelerants, talc, and mixtures thereof.

14. A method comprising:
(a) coating a paper pulp-based article with a prepolymer liquid comprising alkyd oligomers, polyols, excipients, or mixtures thereof in an amount of about 1 gram of the prepolymer liquid per square meter of the article (g/m²) to about 30 g/m²; and,
(b) curing the prepolymer liquid.

15. The method of claim 14, wherein the amount of prepolymer liquid coating the article is about 6 g/m² to about 25 g/m².

16. The method of claim 14, wherein the prepolymer liquid comprises about 45 wt. % to about 99 wt. % water, based on the total weight of the prepolymer liquid, and is substantially free of nonaqueous solvents.

17. A product comprising a paper pulp-based article and an alkyd resin, the product made by a process comprising:
(a) coating the paper pulp-based article with a prepolymer liquid comprising alkyd oligomers, polyols, excipients, or mixtures thereof in an amount of about 1 gram of the prepolymer liquid per square meter of the article (g/m²) to about 30 g/m²; and,
(b) curing the prepolymer liquid.

18. The method of claim 17, wherein the amount of prepolymer liquid coating the article is about 6 g/m² to about 25 g/m².

19. The product of claim 17, wherein the prepolymer liquid comprises about 45 wt. % to about 99 wt. % water, based on the total weight of the prepolymer liquid, and is substantially free of nonaqueous solvents.

20. A pulp-manufacturing method comprising:
(a) adding water and acid or base, in the absence of non-aqueous solvents, to a product comprising a paper pulp-based article and a reprocessable alkyd resin, wherein the alkyd resin is formed in situ with the article and coats the article in an amount, on a dry weight basis, of about 1 gram per square meter of the article (g/m²)to about 20 g/m², and wherein the product has a burst strength determined by TAPPI T810 that is at least 5% greater than that of the article to form a mixture; and,
(b) heating the mixture to a temperature of about 5020 C. to about 120° C. for a period of at least about 3 minutes.
